(19) United States
(12) Patent Application Publication
(10) Pub. No.: US 2018/0084217 A1
(43) Pub. Date: Mar. 22, 2018

(54) LED VIDEO CABINET HAVING A NATIVE 16:9 ASPECT RATIO

(71) Applicant: Aeson LED Display Technologies, Inc., Lakeland, FL (US)

(72) Inventor: Michael Wiener, Lakeland, FL (US)

(73) Assignee: Aeson LED Display Technologies, Inc., Lakeland, FL (US)

(21) Appl. No.: 15/270,684

(22) Filed: Sep. 20, 2016

(51) Int. Cl. H04N 5/64; H04N 9/30; G09G 3/20

(52) U.S. Cl. CPC H04N 5/64; G09G 2300/026; G09G 3/2096; H04N 9/30

(57) ABSTRACT

A light-emitting-diode (LED) video cabinet having a native 16:9 aspect ratio is provided. One embodiment comprises a rectangular frame having a 16:9 aspect ratio; a video display portion mounted to the frame, the video display portion having width and height dimensions such that the video display portion natively displays video information in a 16:9 aspect ratio without a need for aspect-ratio conversion of a video input signal, the video display portion including at least four LED video modules; a video receiving card mounted to the frame, the video receiving card receiving the video input signal and transmitting the video information to the video display portion; and a power supply mounted to the frame, the power supply providing electrical power to the video receiving card and the video display portion. A plurality of such LED video cabinets can be seamlessly joined together to form a LED video display.

### BACKGROUND OF THE INVENTION

The present invention relates to video display systems and, more particularly, to light-emitting-diode (LED) video cabinets that are used as building blocks to create LED video displays used in entertainment venues, stadiums and arenas, churches, boardrooms, television studios, signage, etc.

Standard high-definition (HD) video signals in the United States have a native aspect ratio of 16:9. In many applications, it is desirable to display HD video content on many differing sizes of LED screens, as opposed to projection screens. “LED video screens,” also referred to as “LED video displays” or “LED video walls,” can be mounted to or hung on a wall, suspended from beams, attached to a frame, or ground supported.

In order to assemble an “LED video screen,” a plurality of relatively small “LED video cabinets” are seamlessly joined together to form a unified or integrated screen. A portion of the overall image is displayed on the respective individual video cabinets. The video cabinets may thus be thought of as building blocks that make up a larger display.

LED technology is popular for video applications, but one major disadvantage of prior-art LED video cabinets is that they are square in shape (1:1 aspect ratio), meaning that they are unable to display 16:9 HD video content without the need to stretch, crop, or otherwise manipulate the format of the video signal. This reformatting of the video content results in a distorted image.

It is thus apparent that there is a need in the art for an improved LED video cabinet.

### SUMMARY OF THE INVENTION

One aspect of the present invention is a light-emitting-diode (LED) video cabinet, comprising a rectangular frame having a 16:9 aspect ratio; a video display portion mounted to the frame, the video display portion having width and height dimensions such that the video display portion natively displays video information in a 16:9 aspect ratio without a need for aspect-ratio conversion of a video input signal, the video display portion including at least four LED video modules; a video receiving card mounted to the frame, the video receiving card receiving the video input signal and transmitting the video information to the video display portion; and a power supply mounted to the frame, the power supply providing electrical power to the video receiving card and the video display portion.

Another aspect of the present invention is a video display, comprising a plurality of light-emitting-diode (LED) video cabinets seamlessly joined together in an N×N assembly, where N is equal to the number of LED video cabinets in each row or column of the N×N assembly, the N×N assembly forming a single integrated LED video display having a native aspect ratio of 16:9; wherein each LED video cabinet in the plurality of LED video cabinets includes a rectangular frame having a 16:9 aspect ratio; a video display portion mounted to the frame, the video display portion having width and height dimensions such that the video display portion natively displays video information in a 16:9 aspect ratio without a need for aspect-ratio conversion of a video input signal, the video display portion including at least four LED video modules; a video receiving card mounted to the frame, the video receiving card receiving the video input signal and transmitting the video information to the video display portion; and a power supply mounted to the frame, the power supply providing electrical power to the video receiving card and the video display portion.

These and other features, aspects, and advantages of the present invention will become better understood with reference to the following drawings, description, and claims.

### BRIEF DESCRIPTION OF THE DRAWINGS

FIG. 1 is a front view of a LED video cabinet in accordance with an illustrative embodiment of the invention;

FIG. 2 is a front view of a LED video cabinet with some internal components removed, in accordance with an illustrative embodiment of the invention;

FIG. 3 is a rear view of a LED video cabinet in accordance with an illustrative embodiment of the invention;

FIG. 4 is a rear view of a LED video cabinet with its rear access door removed to show some of the internal components, in accordance with an illustrative embodiment of the invention;

FIG. 5 is a front view of a rear access door of a LED video cabinet, in accordance with an illustrative embodiment of the invention;

FIG. 6 is a right-side view of a LED video cabinet, in accordance with an illustrative embodiment of the invention;

FIG. 7 is a left-side view of a LED video cabinet, in accordance with an illustrative embodiment of the invention;

FIG. 8 is a top view of a LED video cabinet, in accordance with an illustrative embodiment of the invention; and

FIG. 9 is a front view of a LED video display made up of a plurality of LED video cabinets, in accordance with an illustrative embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention is a light-emitting-diode (LED) video cabinet having a native aspect ratio of 16:9. Such a LED video cabinet is thus capable of displaying a video signal in a 16:9 aspect ratio without the need for cropping, stretching, or other manipulation or reformatting of the video content. That is, such a LED video cabinet allows a video image to be displayed in the exact 16:9 aspect ratio and resolution in which it was shot. A plurality of such LED video cabinets can be seamlessly joined together in an N×N assembly to create a larger HD LED video display that also has a native aspect ratio of 16:9, where N is the number of LED video cabinets in a given row or column of the N×N assembly.

In this Detailed Description, a “LED video cabinet” is an electronic device that can be joined with like or similar devices to form a unified or integrated LED video “display” or “screen,” each LED video cabinet displaying a portion of the overall image. A “LED video module” is a LED video display element that forms part of a LED video cabinet.

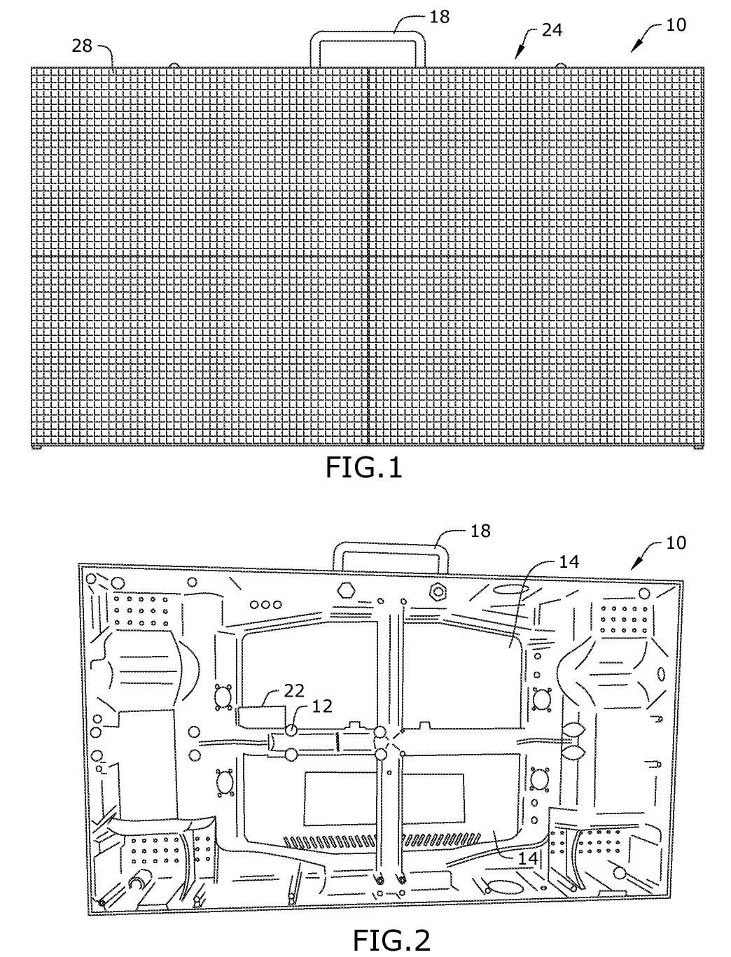

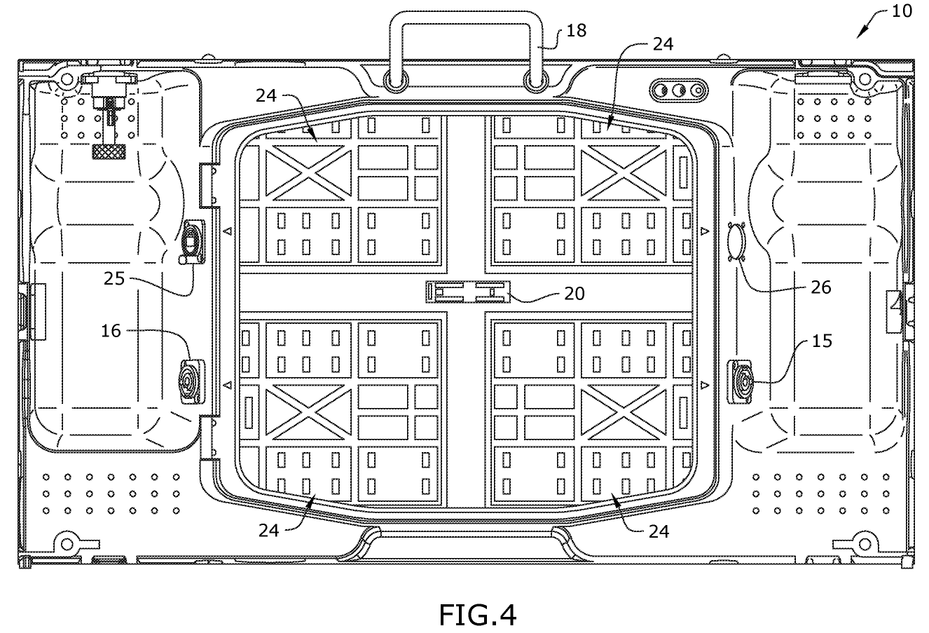

Referring to the drawings, FIG. 1 is a front view of a LED video cabinet in accordance with an illustrative embodiment of the invention. FIGS. 2-8 refer to this same illustrative embodiment. The embodiment shown in FIG. 1 includes a die cast aluminum frame 10. In other embodiments, frame 10 can be made of a different material. Frame 10 has dimensions (width and height) such that it has a native aspect ratio of 16:9. Some specific dimensions associated with certain embodiments are discussed below. In the embodiment depicted in FIG. 1, the LED video cabinet includes four LED video modules 24 (see also FIG. 4 and the description below) made up of LED display elements 28. LED video modules 24 are designed and fabricated in accordance with the 16:9 aspect ratio of frame 10. In other embodiments, the LED video cabinet can include more than four LED video modules. The four or more LED video modules 24 may collectively be termed a “video display portion” of the LED video cabinet. The video display portion natively displays video information in a 16:9 aspect ratio without a need for aspect-ratio conversion of a video input signal. For convenience in carrying and placing the LED video cabinet in a storage container, it also includes a carry handle 18.

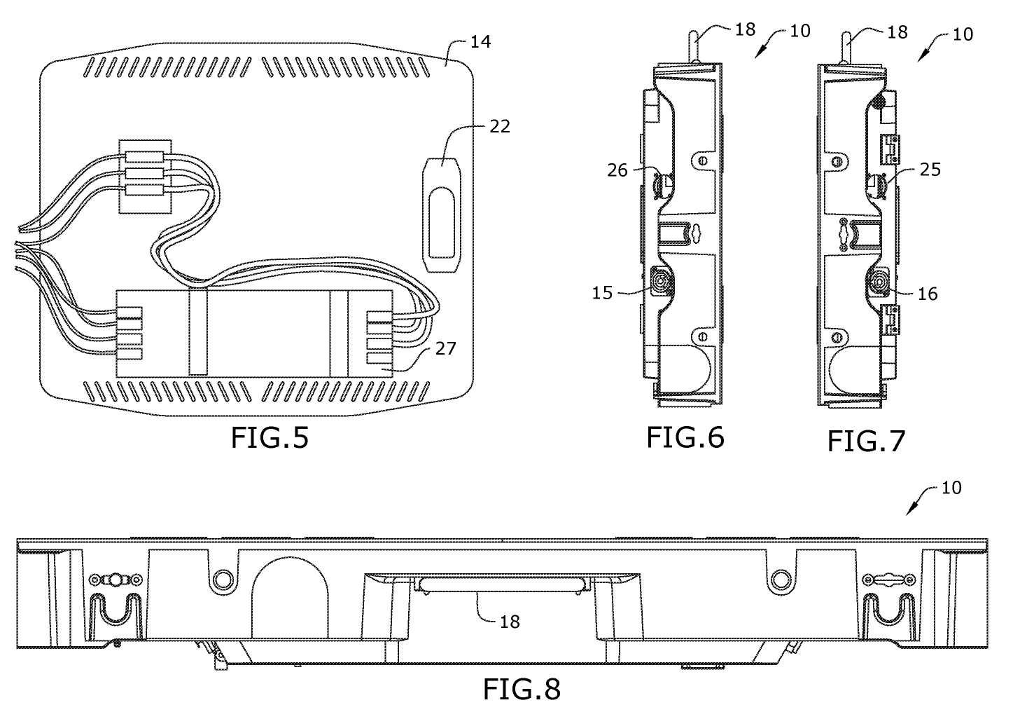

FIG. 2 is a front view of a LED video cabinet with some internal components removed, in accordance with an illustrative embodiment of the invention. In FIG. 2, internal components such as the four LED video modules 24 have been removed. The view in FIG. 2 shows the inside surface of rear access door 14, cover locking latch 22 that latches rear access door 14, and magnetic module mounts 12 that permit the magnetic LED video modules 24 to attach to frame 10. Rear access door 14 protects power supply 27 and video receiving card 20 (see FIGS. 4-5).

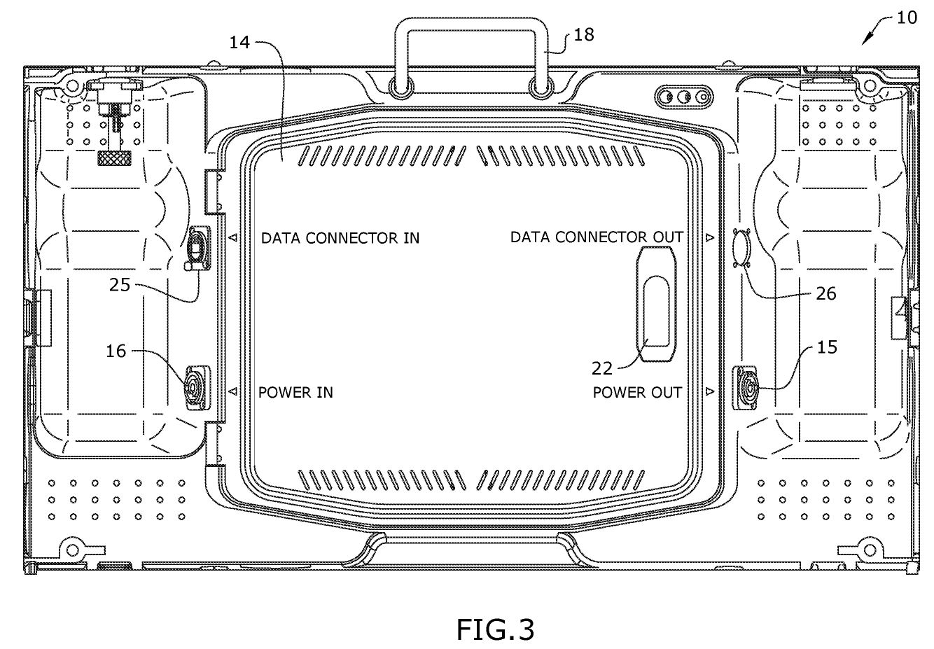

FIG. 3 is a rear view of a LED video cabinet in accordance with an illustrative embodiment of the invention. In FIG. 3, the outside surface of rear access door 14 is visible, and this view also shows cover locking latch 22, which holds rear access door 14 closed, when cover locking latch 22 is engaged. As shown in FIG. 3, the LED video cabinet also includes power input connector 16 for receiving incoming power and power output connector 15 for daisy chaining power to other LED video cabinets that are joined together to form a display or screen. The LED video cabinet also includes video data input connector 25, which receives an input video signal, and video data output connector 26, which permits daisy chaining the video signal to other LED video cabinets that are joined together to form a LED video display or screen.

FIG. 4 is a rear view of a LED video cabinet with its rear access door removed to show some of the internal components, in accordance with an illustrative embodiment of the invention. In FIG. 4, the rear (inside) surface of the four LED video modules 24 is visible. The LED video cabinet includes a video receiving card 20 that is mounted to frame 10. Video receiving card 20 receives an input video signal (e.g., an HD video signal) and processes it in a manner that renders the received video information compatible with the LED video modules 24. That is, video receiving card 20 provides an interface between the input video signal received via video data input connector 25 and the LED video modules 24. One example of a suitable video receiving card is a Novastar MRV210, which includes a LED video controller that is compatible with LED video modules 24. In some embodiments, redundant video receiving cards 20 are added to provide greater reliability, in case a video receiving card 20 malfunctions or wears out.

FIG. 5 is a front view of a rear access door of a LED video cabinet, in accordance with an illustrative embodiment of the invention. As shown in FIG. 5, the LED video cabinet includes a power supply 27. In one embodiment, power supply 27 is a 5-volt DC power supply. Power supply 27 provides electrical power to video receiving card 20 and the video display portion of the device, which includes the LED video modules 24. In some embodiments, additional redundant power supplies 27 are added to the LED video cabinet for greater reliability, in case a power supply 27 fails.

FIGS. 6, 7, and 8 are, respectively, right-side, left-side, and top views of a LED video cabinet, in accordance with an illustrative embodiment of the invention. The labeled elements in those figures were discussed above in connection with FIGS. 1-5.

The specific dimensions of an embodiment of the inventive LED video cabinet varies, depending on the specific application. The process of designing a LED video cabinet begins with an assumption regarding how many LED video cabinets will be required to achieve a specific desired pixel pitch, which, in turn, determines the size of each cabinet.

For example, if one desires to calculate the pixel pitch and cabinet size for an integrated LED video screen that is 12 LED video cabinets wide×12 LED video cabinets high, one would divide 1920 pixels (the width in pixels of a HD image) by 12, yielding 160 pixels. One would then divide 1080 pixels (the height in pixels of a HD image) by 12, yielding 90 pixels. Through trial and error, one can establish that a pixel pitch of 4 would result in a LED video cabinet that is 640 mm×360 mm, a perfect 16:9 aspect ratio and resolution (160 pixels×4=640 mm, and 4×90 pixels=360 mm).

Once a suitable pixel pitch has been determined, again, through trial and error, other pixel pitches can be considered to determine whether they will work with a cabinet that is 640 mm×360 mm. For example, with 15 cabinets horizontally and vertically for a total of 225 cabinets and using the same method explained above, it was discovered that a Pixel pitch of 5 results in 128 pixels×72 pixels per cabinet and a cabinet that is also 640 mm×360 mm. Through further trial and error calculations, it was established that the following pixel pitches work with a cabinet that is 640 mm×360 mm: P6.67, P3.34, P2.85, P2, P1.667, and P1.33, where “P” denotes “pixel pitch.” Using similar logic, it has been determined that cabinets that are 600 mm×337.5 mm and 609.92 mm×343.08 mm also yield pixel pitches that result in HD resolution at an aspect ratio of 16:9.

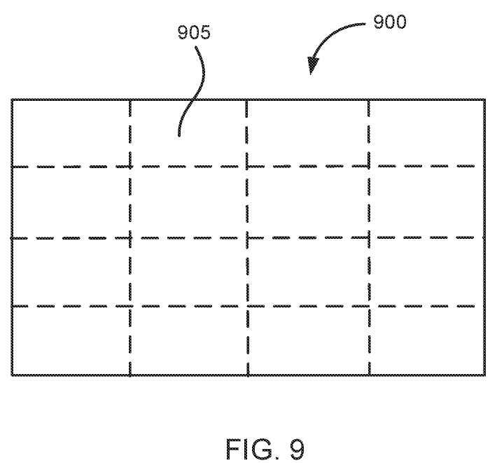

FIG. 9 is a front view of a LED video display 900 made up of a plurality of LED video cabinets 905, in accordance with an illustrative embodiment of the invention. In this application, a plurality of LED video cabinets 905 such as that described above in connection with FIGS. 1-8 are seamlessly joined together in an N×N assembly to create an integrated LED video display having a native aspect ratio of 16:9, where N is the number of LED video cabinets in a given row or column of the N×N assembly. As explained above, each LED video cabinet 905 has an aspect ratio of 16:9, so the resulting LED video display 900 also has an aspect ratio of 16:9. In the simplified example of FIG. 9, 16 LED video cabinets 905 are used (4×4). In other applications, that number could be smaller or larger. The dashed lines in FIG. 9 indicate that the seams or boundaries delineating the individual LED video cabinets 905 are not visible.

It should be understood, of course, that the foregoing relates to exemplary embodiments of the invention and that modifications may be made without departing from the spirit and scope of the invention as set forth in the following claims.

What is claimed is:

1. A light-emitting-diode (LED) video cabinet, comprising:
a rectangular frame having a 16:9 aspect ratio;
a video display portion mounted to the frame, the video display portion having width and height dimensions such that the video display portion natively displays video information in a 16:9 aspect ratio without a need for aspect-ratio conversion of a video input signal, the video display portion including at least four LED video modules;
a video receiving card mounted to the frame, the video receiving card receiving the video input signal and transmitting the video information to the video display portion; and
a power supply mounted to the frame, the power supply providing electrical power to the video receiving card and the video display portion.

2. The LED video cabinet of claim 1, further comprising:
one or more power connectors; and
one or more data connectors.

3. The LED video cabinet of claim 1, wherein the video display portion includes four LED video modules.

4. The LED video cabinet of claim 1, wherein the frame measures 640 mm×360 mm.

5. The LED video cabinet of claim 1, wherein the frame measures 600 mm×337.5 mm.

6. The LED video cabinet of claim 1, wherein the frame measures 609.92 mm×343.08 mm.

7. The LED video cabinet of claim 1, wherein the frame is made of die cast aluminum.

8. The LED video cabinet of claim 1, further comprising an additional power supply to increase reliability of the LED video cabinet through redundancy.

9. The LED video cabinet of claim 1, further comprising an additional video receiving card to increase reliability of the LED video cabinet through redundancy.

10. A light-emitting-diode (LED) video cabinet, comprising:
rectangular structural means having a 16:9 aspect ratio;
means, mounted to the structural means, for displaying video, the means for displaying video having width and height dimensions such that the means for displaying video natively displays video information in a 16:9 aspect ratio without a need for aspect-ratio conversion of a video input signal, the means for displaying video including at least four LED video modules;
means, mounted to the structural means, for receiving the video input signal and transmitting the video information to the means for displaying video; and
means, mounted to the structural means, for supplying electrical power to the means for displaying video and the means for receiving the video input signal and transmitting the video information to the means for displaying video.

11. A video display, comprising:
a plurality of light-emitting-diode (LED) video cabinets seamlessly joined together in an N×N assembly, where N is equal to the number of LED video cabinets in each row or column of the N×N assembly, the N×N assembly forming a single integrated LED video display having a native aspect ratio of 16:9;
wherein each LED video cabinet in the plurality of LED video cabinets includes:
a rectangular frame having a 16:9 aspect ratio;
a video display portion mounted to the frame, the video display portion having width and height dimensions such that the video display portion natively displays video information in a 16:9 aspect ratio without a need for aspect-ratio conversion of a video input signal, the video display portion including at least four LED video modules;
a video receiving card mounted to the frame, the video receiving card receiving the video input signal and transmitting the video information to the video display portion; and
a power supply mounted to the frame, the power supply providing electrical power to the video receiving card and the video display portion.

12. The video display of claim 11, wherein each LED video cabinet in the plurality of LED video cabinets further includes:
one or more power connectors; and
one or more data connectors.
